(19) United States
(12) Patent Application Publication
(10) Pub. No.: US 2025/0180419 A1
(43) Pub. Date: Jun. 5, 2025

(54) TORQUE APPLICATION SYSTEM

(71) Applicants: PETRÓLEO BRASILEIRO S.A. - PETROBRAS, Rio de Janeiro (BR); UNIVERSIDADE ESTADUAL DE CAMPINAS, Campinas (BR)

(72) Inventors: RONALDO LUCAS ALKMIN FREIRE, São José dos Campos (BR); JONY JAVORSKI ECKERT, Campinas (BR); ÁQUILA CHAGAS DE CARVALHO, Campinas (BR); LEONARDO ISHIMOTO, Santos (BR); HELIO FIORI DE CASTRO, Campinas (BR); FRANCO GIUSEPPE DEDINI, Campinas (BR); LUCAS NOGUEIRA GARPELLI, Campinas (BR)

(73) Assignees: PETRÓLEO BRASILEIRO S.A. - PETROBRAS, Rio de Janeiro (BR); UNIVERSIDADE ESTADUAL DE CAMPINAS, Campinas (BR)

(21) Appl. No.: 18/965,660

(22) Filed: Dec. 2, 2024

(30) Foreign Application Priority Data
Dec. 2, 2023 (BR) 1020230253628

(51) Int. Cl. G01L 3/14

(52) U.S. Cl. CPC G01L 3/1407; G01L 3/1464

(57) ABSTRACT

A torque application system for use in mechanical circuits and offset flanges is described. More precisely, the system of the invention comprises a set of elements that apply torque to the region of offset flanges capable of eliminating gaps in closed mechanical systems, wherein this set of components responsible for applying torque, in addition to promoting permanent contact of the mechanical system, allows a previously known load to be imposed. Accordingly, the system described herein allows analysis cycles to be achieved under different operating conditions that require smoothness, given the more uniform behavior of the mechanical system under analysis. Furthermore, due to internal load compensation means, the torque application system prevents overloads in the mechanical system, since compensating means provided with springs compensate for possible misalignments that could result in permanent plastic deformations in the elements to which the set of components of the torque applicator is coupled.

### CROSS-REFERENCE TO RELATED APPLICATION

The present application claims the benefit of Brazilian Patent Application No. BR1020230253628, filed Dec. 2, 2023, the entire contents of which are fully incorporated herein by reference.

### FIELD

The present invention is within the field of mechanical circuit systems where it is desired to emulate a load, or simply eliminate a gap between components, in order to perform tests and measurements of some mechanical component to be assessed when subjected to different loads in a controlled environment.

### BACKGROUND

The present invention seeks to address a common problem in carrying out tests and measurements on mechanical components: the presence of gaps in the systems and the difficulty in promoting controlled loading. Often times, gaps in mechanical components and the backlash in geared systems introduce unwanted noise, compromising quality of the data acquired during the experiments. To solve this challenge, the invention proposes the use of a torque applicator with offset flanges, which eliminates gaps and allows the application of controlled loads, resulting in better quality signal acquisition.

One of the remarkable advantages of this approach is the standardization of operating conditions in experiments. This can ensure that the mechanical components are subjected to the same loading levels across all measurements, providing more reliable and reproducible results. Furthermore, elimination of existing gaps in the mechanical components and the backlash in geared systems enhance the reduction of unwanted noise generated in the system, making measurements more accurate.

An additional benefit of this innovation is that the test systems are made simpler. Since the offset flange torque applicator makes it easier to achieve controlled loadings and eliminates gaps between components, it is possible to operate with less complex systems, saving resources and time. This makes the invention a valuable solution for carrying out tests and measurements on mechanical components in controlled environments. In summary, the present invention aims to significantly improve quality of data obtained in mechanical experiments, while simplifying the testing processes.

### STATE OF THE ART

In the State of the Art some torque application systems are currently available, which mention the ability to adjust mechanical systems; however, they all have significant differences from the invention proposed herein. For example, in the State of the Art there is system having adjusting screws with rods surrounding a flange region, not even capable of providing tests with predetermined loads in closed mechanical systems.

Below some of the publications available in the State of the Art of the present invention are presented together with comparative comments with the art now described and claimed.

Document U.S. Pat. No. 4,899,596A describes a system, method and device for measuring the torque transmitted by a drive shaft, and automatically compensating for variations in wall thickness exhibited by different drive shafts having the same nominal dimensions. It is particularly suitable for use with measuring devices described in patent U.S. Pat. No. 3,548,649 and patent U.S. Pat. No. 4,488,443. In portraying its Prior Art, U.S. Pat. No. 4,899,596A mentions that systems have been developed for measuring transmitted shaft torque by measuring the “twist” or torsional deflection of a length of the shaft while it is under a torsional load. Therefore, it is clearly a technical field different from that of the present invention. Adjustment screws having arms surrounding a flange region are not observed. Moreover, it is clear that U.S. Pat. No. 4,899,596A is not intended to provide tests with predetermined loads in closed mechanical systems.

Document US2011239430AA, in turn, is part of a context focused on cambering, alignment of the angle between the vertical axle of the wheel and the vertical axle of the vehicle. There is no mention of closed mechanical industrial circuits. Accordingly, concerning the construction aspects, no adjustment screw having rods to be arranged in the flange region is observed. US2011239430AA also lacks the ability to apply a predetermined load and to assess the behavior of mechanical system elements under controlled conditions.

Document CN2317351Y provides information on a spring system for adjusting the connection between flanges and absorbing impacts. However, the physical structure differs considerably from the proposed invention, since adjustment screws for torque and rods for applying torque are not mentioned. Furthermore, CN2317351Y does not provide important information on the application of a predetermined load in closed mechanical circuits to evaluate an element, as will be described in the present invention.

By this review of the State of the Art, it can be noted that none of the documents found to date reach a torque application system in mechanical circuits and in the region of offset flanges, wherein said system eliminates gaps in closed systems, being capable of promoting permanent contact between the approximated elements. Furthermore, the system of the present invention is capable of imposing a previously known static load, which makes it possible to assess the behavior of elements under controlled conditions. Finally, the system of the invention allows for compensation of loads to be carried out with a spring mechanism and, in this instance, it is still capable of avoiding overloads.

### SUMMARY

The present invention relates to a torque application system capable of applying torque to regions of offset flanges, promoting permanent contact between elements, preventing overloads, eliminating gaps, and imposing a previously known load, said system comprising: an input flange (01), an output flange (02), compensating means with springs (03), double roller bearings (04), the output flange axis (05), the input flange axis (06), compensating means bearings (07), upper rod (08), lower rod (09), adjustment screw (10), articulated nut (11), upper support (12), upper joint (13), lower support (14), oblong attachment screws (15), oblongs (16), springs (17), articulated pins (18), spring abutment (19), input flange attachment screws (20), and output flange attachment screws (21).

In its main embodiment, the system proposed herein can be used, at least, in closed mechanical circuits, inspection benches of geared systems or benches of bearing sensing system.

In particular, the input flange (01) is parallel to the output flange, wherein immediately after the output flange (02), a first double roller bearing (04) is arranged supported centrally by a preferably column-type base, through which the axis of the output flange (05) passes. At the opposite end to the axis of the output flange (05), a second double roller bearing (04) is centrally supported by a preferably of the column type base, through which the axis of the input flange (06) passes, each of said bases preferably of the column type having a base structure coupled to its lower end, with a cross-section larger than the cross-section of the column itself.

Furthermore, the input flange (01) is provided with holes around its outer periphery containing internally the compensating means with springs (03), with compensating means bearings (07).

Additionally, the preferred embodiment of the invention described herein has the upper rod (08) and the lower rod (09) mirrored relative to each other in order to embrace the circumferential structure of said system, adopting a preferably rectangular cross-section, wherein a first end receives an angled cut that coincides exactly with the circular shape of the input flange (01). At the center of said angled cut a hole is arranged, which receives a screw passing through the rod towards one of the holes available around the outer periphery of the input flange (01). At the second end of said rods (08, 09) an adjustment screw (10) crosses both rods, the screw body being integrally threaded, and the lower end of the adjustment screw (10) contacting an articulated nut (11) while the upper end of the adjustment screw (10) contacts an upper support (12) provided on an upper joint (13) in the form of a block with a hollow central structure capable of being crossed by the adjustment screw (10), and where a tightening screw is provided at an opposite position to the upper support (12). In turn, a lower support (14) is provided in the form, block with a hollow central structure capable of being crossed by the adjustment screw (10) at the lower end of the adjustment screw (10) which contacts the lower rod (09).

In particular, it can be noted that the output flange (02) has a plurality of oblong attachment screws (15) spaced apart from each other along its outer circumference, where adjustment of the adjustment screw (10) causes movement of the oblong attachment screws (15) along the path of oblong slots (16) where they are arranged. The body of said oblong attachment screws (15) passes through the oblongs (16) and passes beyond the thickness of the output flange (02) in order to couple to the input flange (01).

Furthermore, the preferred and non-restricted embodiment disclosed herein has articulated pins (18) available around the circumference of the input flange (01), coupling to fitting structures available coincidentally along the circumference of the output flange (02) in order to promote coupling between the input and output flanges (01, 02) with the contribution of the input flange attachment screws (20) and the output flange attachment screws (21).

### BRIEF DESCRIPTION OF THE FIGURES

FIG. 1 is a graphical representation of the torque applicator system of the present invention from two perspectives; that is, from the perspective of the output flange and from the perspective of the input flange.

FIG. 2 presents a graphical representation of a side view of the torque application system of the present invention, which aims to detail especially the bearings of said system.

FIG. 3 is a graphical representation of the torque application system of the present invention, which aims to detail in particular the rods used in angular offsets of said system.

FIG. 4 is a graphical representation of the torque application system of the present invention, which aims to detail in particular the compensating means provided with springs of said system.

FIG. 5 is a graphical representation in exploded view of the torque application system of the present invention, which aims to provide an even more detailed view of the compensating means provided with springs of said system.

FIG. 6 is a graphic and diagrammatic representation of the torque application system of the present invention in a front view proposed for the output flange (02) and for the compensating means provided with springs (03), wherein the goal is to represent the motion relationship between its constituent components.

### DETAIL DESCRIPTION OF THE FIGURES

The present invention describes a torque application system for use in mechanical circuits and by offset flanges. More precisely, the system of the invention comprises a set of elements that apply torque to the region of offset flanges capable of eliminating gaps in closed mechanical systems, wherein this set of components responsible for applying torque, in addition to promoting permanent contact of the mechanical system, allows a previously known load to be imposed. Accordingly, the system described herein allows analysis cycles to be achieved under different operating conditions that require smoothness, given the more uniform behavior of the mechanical system under analysis. Furthermore, due to internal load compensation means, the torque application system prevents overloads in the mechanical system, since compensating means provided with springs compensate for possible misalignments that could result in permanent plastic deformations in the elements to which the set of components of the torque applicator is coupled.

A practical example of the use of the invention is the application of the system in closed mechanical circuits, where one desires to emulate a load or simply eliminate a gap, in order to perform tests and measurements on some mechanical components to be assessed when subjected to different loads in a controlled environment.

To this end, the system comprises, at least:
an input flange (01);
an output flange (02);
compensating means provided with springs (03);
double roller bearings (04);
axis of the output flange (05);
axis of the input flange (06);
bearings of the compensating means (07);
upper rod (08);
lower rod (09);
adjustment screw (10);
articulated nut (11);
upper support (12);
upper joint (13);
bottom support (14);
oblong attachment screws (15);
oblongs (16);
springs (17);
articulated pins (18);
spring abutment (19);
input flange attachment screws (20);
Output flange attachment screws (21).

As examples of a direct application of the invention, inspection benches for geared systems, or benches for bearing sensing systems can be cited.

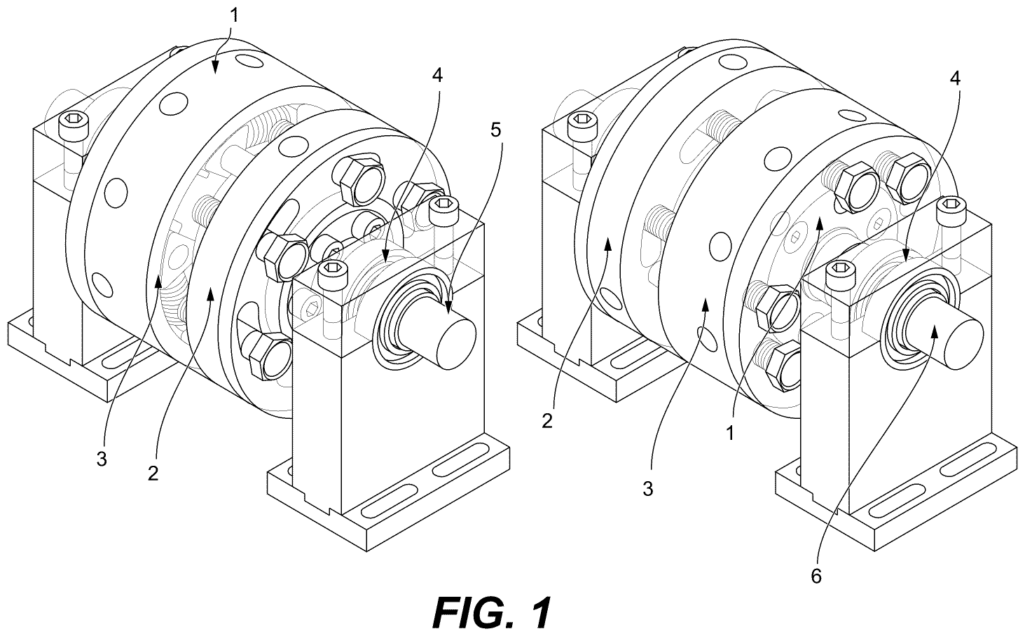

FIG. 1 is a graphical representation of the torque application system of the present invention from two perspectives. In particular, FIG. 1 depicts that the input flange (01) is parallel to the output flange (02). In said FIG. 1, on the left, is a view from the initial perspective starting from the output flange (02), while in the image on the right the demonstration perspective begins with the input flange (01). Internally to the input flange (01) compensating means provided with springs (03) are arranged. Meanwhile, immediately after the output flange (02), a double roller bearing (04) can be found, which is supported centrally by a base that is preferably of the column type, wherein passing through said double roller bearing (04) is the axis of the output flange (05). At the end just opposite to the axis of the output flange (05) is a second double roller bearing (04), also supported centrally by a second base, that is preferably of the column type, wherein the axis of the input flange (06) passes through said double roller bearing (04). Therefore, as illustrated in FIG. 1, two columns support the input and output flanges (01, 02) through roller bearings (04) arranged parallel to the central region of the columns. At each of the said columns, precisely at the lower end, is a base having a cross-section larger than the column, further contributing to the support of the system.

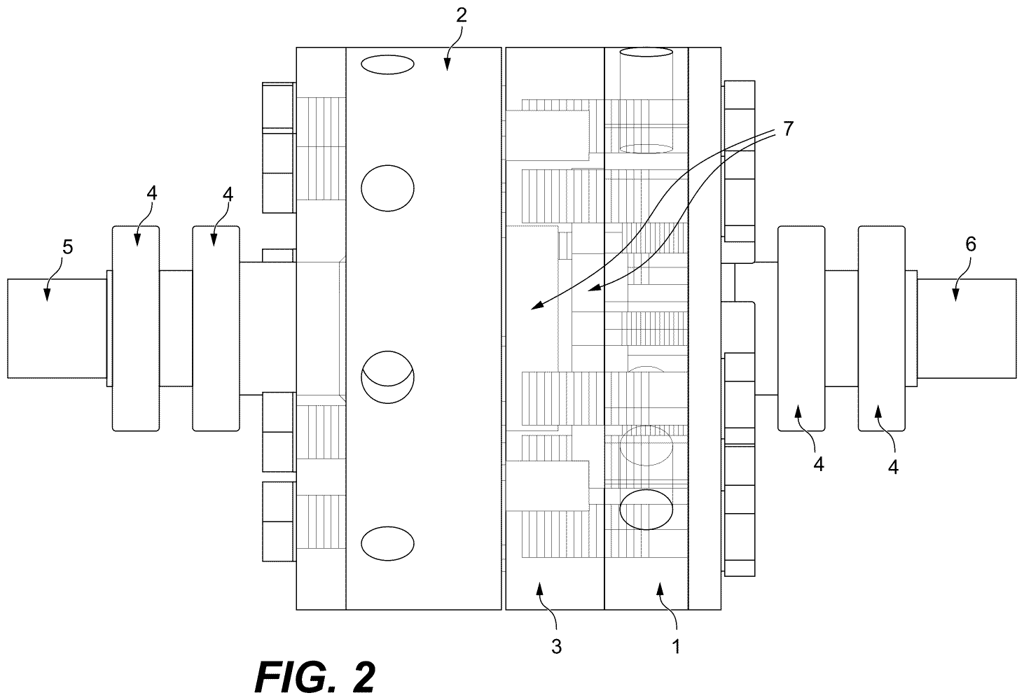

FIG. 2 presents a graphical representation of a side view of the torque application system of the present invention, which aims to detail especially the bearings of said system. The aforementioned FIG. 2 contributes to the perfect description of the invention by demonstrating the spacing between the component elements of its system. Precisely, an input composition and an output composition of the components of the invention are indicated in more detail: the input flange (01) to which the axis of the input flange (06) belongs internally contains compensating means with springs (03). Furthermore, in said FIG. 2, two additional bearings can be identified by reference number 07, these bearings being the bearings of the compensating means (07). Moving towards the central region of the system, immediately after the arrangement of the bearings of the compensating means (07), a brief spacing anticipates the output flange arrangement (02), to which the axis of the output flange (05) belongs.

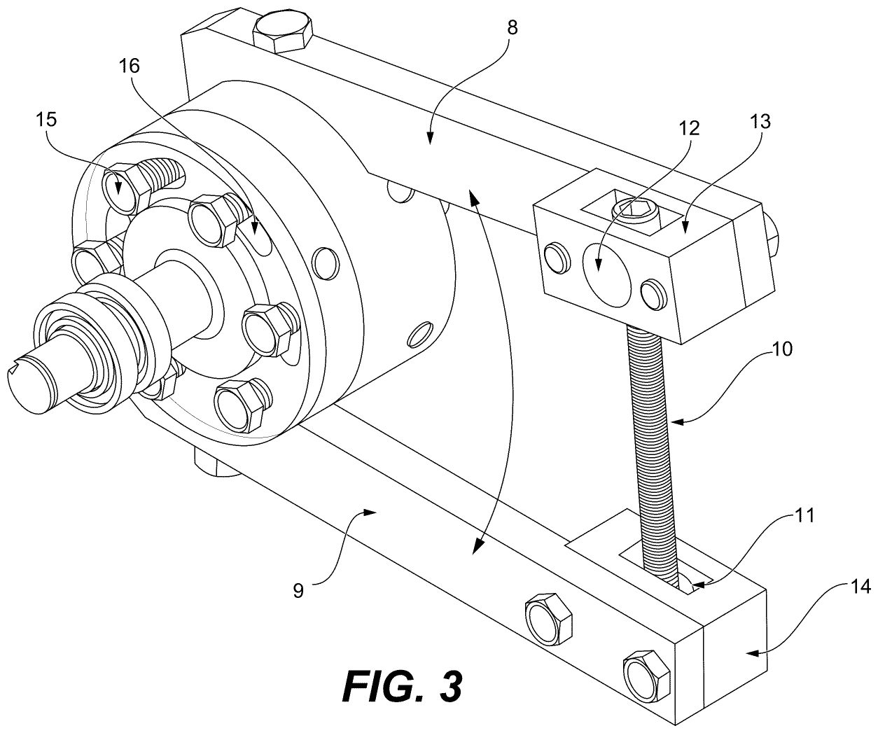

FIG. 3 is a graphical representation of the torque application system of the present invention, which aims to detail in particular the rods used in angular offsets of said system. Precisely, an upper rod (08) and a lower rod (09) are used in a mirrored manner relative to each other. Concerning their shape, the rods comprise a preferably rectangular cross-section, wherein a first end receives an angled cut that coincides exactly with the circular shape of the input flange (01). At the exact center of this angled cut, a hole is made to receive a screw that passes through the rod towards one of the holes available around the outer periphery of the input flange (01). Meanwhile, at the second end of the rods (08, 09) an adjustment screw (10) crosses both rods, the screw body being integrally threaded. The lower end of the adjustment screw (10), that is, the one that contacts the lower rod (09), receives an articulated nut (11). Meanwhile, the upper end of the adjustment screw (10), that is, the one that contacts the upper rod (08), receives the coupling to an upper support (12) provided in an upper joint (13) in the form of a block having a hollow central structure capable of being crossed by the adjustment screw (10). It should also be noted that, opposite the upper support (12) there is provided a screw for tightening. Similarly, that is, in the form of a block with a hollow central structure capable of being crossed by the adjustment screw (10), a lower support (14) is provided at the lower end of the adjustment screw (10) that contacts the lower rod (09). It is precisely the tightening or slack on the adjustment screw (10) that causes the system to move, which in turn will cause the offset adjustment aimed at by the invention.

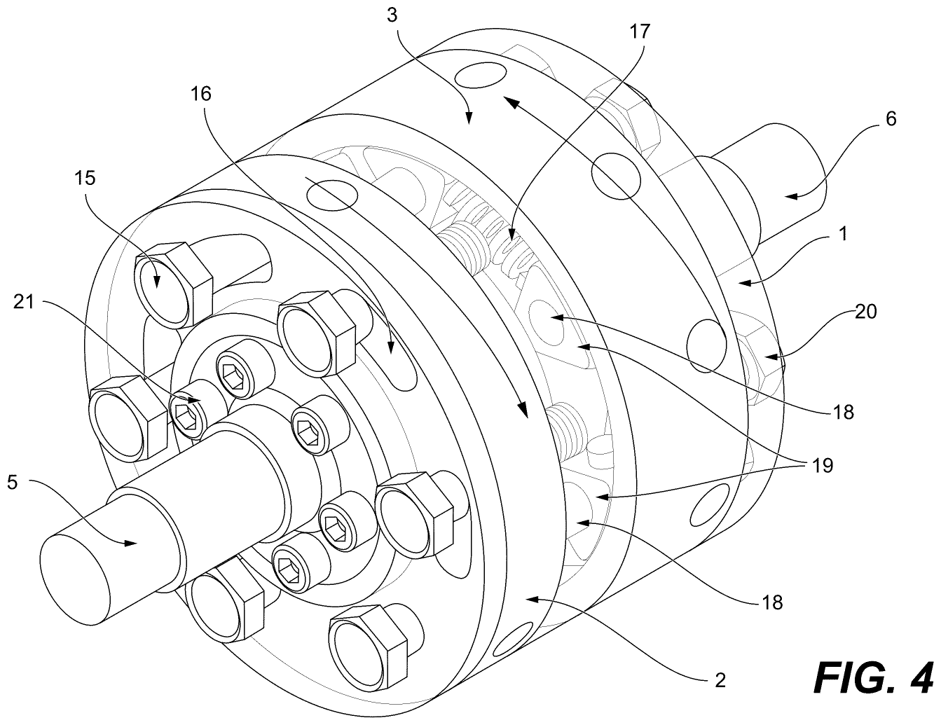

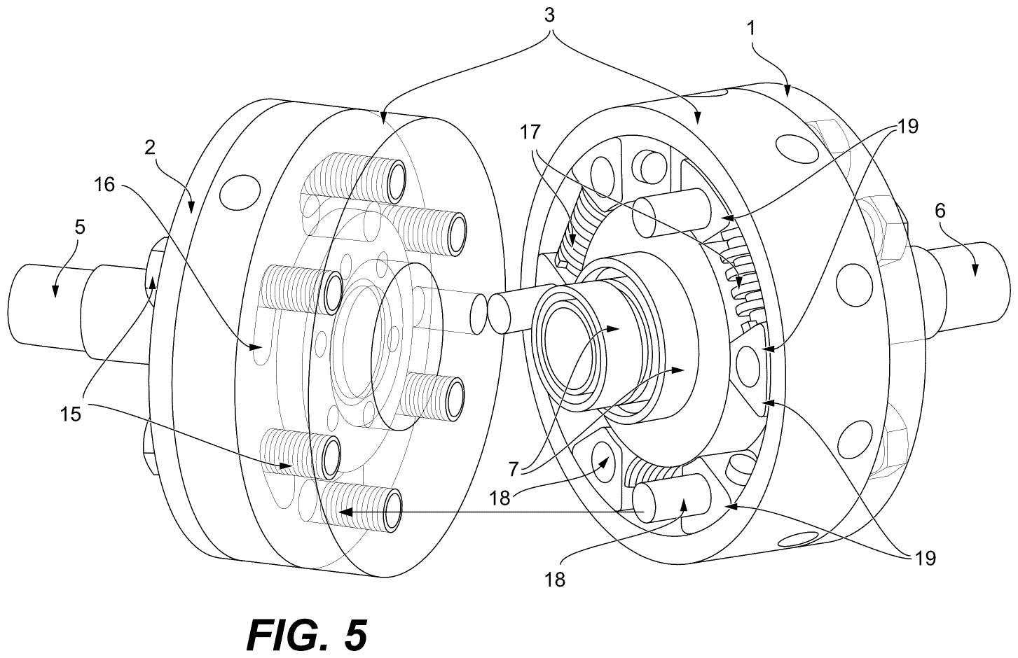

FIG. 4 is a graphical representation of the torque application system of the present invention, which aims to detail in particular the compensating means provided with springs of said system. In addition to this detail, FIG. 5 presents a graphic representation in exploded view, which aims to provide an even more specific view of the compensating means with springs.

In the part corresponding to the output flange (02) a plurality of oblong attachment screws (15) is arranged spaced apart along the circumference of the output flange (02). By moving the system by adjusting the adjustment screw (10), the oblong attachment screws (15) move along the path of the oblong slots (16) where they are arranged. It should be understood that the head of the oblong attachment screws (15) is accessible in part of the output flange (02), while the body of said oblong attachment screws (15), passing through the oblongs (16), passes beyond the thickness of the output flange (02) in order to couple with the input flange (01).

Coupling between (input 01 and output 02) flanges takes place through the connection between the articulated pins (18) available around the circumference of the input flange (01), which find matching structures available coincidentally along the internal circumference of the output flange (02). An arrow present in the illustration in FIG. 5 perfectly indicates such coupling. Moreover, the input flange attachment screws (20) and the output flange attachment screws (21) are involved in this coupling.

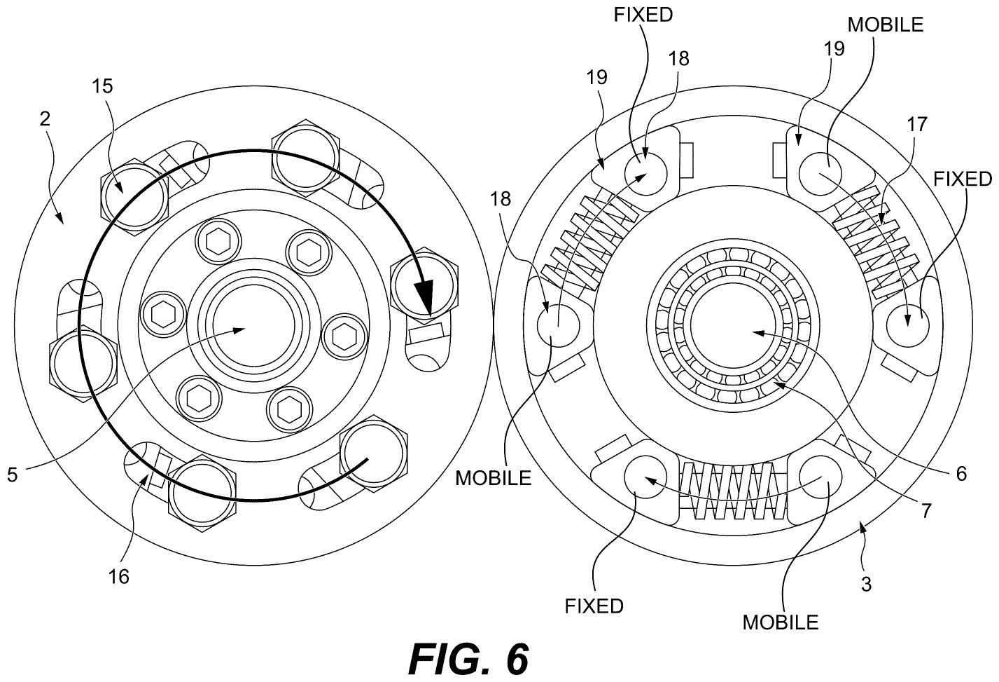

FIG. 6 proposes a graphic and diagrammatic representation of the torque application system of the present invention in a front view proposed for the output flange (02) and for the compensating means provided with springs (03), wherein the is proposed to represent the motion relationship between its constituent components. In the part corresponding to the input flange (01) a plurality of springs (17) are spaced apart around the inner circumference of the input flange (01). Each spring is arranged between two articulated pins (18), where the first pin is fixed and the second pin is movable. The spacing between each spring (17) is provided by a distance between a mobile structure and a fixed structure of articulated pins (18); the said assembly that provides such spacing is referenced to as spring abutment (19).

The torque application system described herein must be installed between the components to which an angular offset is desired, generating torques in closed mechanical circuits, or between components in which the angular offset between the flanges must eliminate existing gaps. Axes connected to the respective flanges of the applicator must be coupled to the axes of the machine components where the torque applicator is installed. These machine axes must be placed immediately before and after the torque applicator, being connected by means of couplings to the axes of the torque applicator system to eliminate misalignments. In the instance of mechanical circuits instrumented with torque meters, it is possible to precisely calibrate the torque applied to the system, since during the angular offset process of the torque applicator, it is possible to monitor the existing torque through the torque meter. Once the desired torque load is reached, the torque applicator is locked by tightening the flange attachment screws, preventing the applied angular offset from being reversed by removing the load application rods, thus conserving the torque applied to the system. With the system angularly offset and locked, it is possible to perform the equipment operation, with the torque applied to the closed circuit, thus emulating the effect of a possible load. In cases of potential overloads arising from operation of the equipment, such as misalignments, the internal spring system of the torque applicator will absorb a portion of this overload, thus avoiding plastic deformations in the components. Finally, at the end of the operation, the torque of the system is released by loosening the screws that lock the relative movement between the flanges.

The present invention is described herein in terms of its preferred embodiment. A person skilled in the art in possession of the information described herein is perfectly capable of noticing that changes can be made based on this specification, with such changes still being included within the scope described and claimed.

1. A torque application system, comprising:
an input flange;
an output flange;
compensating means with springs;
double roller bearings;
axis of the output flange;
axis of the input flange;
bearings of the compensating means;
upper rod;
lower rod;
adjustment screw;
articulated nut;
upper support;
upper joint;
bottom support;
oblong attachment screws;
oblongs;
springs;
articulated pins;
spring abutment;
input flange attachment screws; and
output flange attachment screws.

2. The system of claim 1, wherein at least in closed mechanical circuits inspection benches of geared systems or benches of bearings sensing systems are used.

3. The system of claim 1, wherein:
the input flange is parallel to the output flange,
immediately after the output flange, a first double roller bearing is arranged supported centrally by a first column-type base, through which the axis of the output flange passes,
at the opposite end to the axis of the output flange, a second double roller bearing is centrally supported by a second column-type base, through which the axis of the input flange passes, and
each of said bases having a base structure coupled to its lower end, with a cross-section larger than the cross-section of the column itself.

4. The system of claim 1, wherein:
the input flange is provided with holes around its outer periphery, and internally it contains compensating means with springs with compensating means bearings,
a plurality of springs is spaced apart by the inner circumference of the input flange, each spring being arranged between two articulated pins, with a first pin fixed and a second pin being movable, and
each spring installed between the two articulated pins is in turn spaced by a spring abutment.

5. The system of claim 1, wherein:
the upper rod and the lower rod are mirrored relative to each other in order to embrace the circumferential structure of said system, adopting a preferably rectangular cross-section, wherein a first end receives an angled cut that coincides exactly with the circular shape of the input flange,
at the center of said angled cut a hole is arranged, which receives a screw passing through the rod towards one of the holes available around the outer periphery of the input flange, and
at the second end of said rods an adjustment screw crosses both rods, the screw body being integrally threaded,
the lower end of the adjustment screw contacts an articulated nut while the upper end of the adjustment screw contacts an upper support provided on an upper joint in the form of a block with a hollow central structure capable of being crossed by the adjustment screw, and where a tightening screw is provided at an opposite position to the upper support, and
a lower support is provided in the form of a block with a hollow central structure capable of being crossed by the adjustment screw at the lower end of the adjustment screw which contacts the lower rod.

6. The system, according to claim 1, wherein:
the output flange has a plurality of oblong attachment screws spaced apart from each other along its internal circumference, wherein adjustment of the adjustment screw causes movement of the oblong attachment screws along the path of oblong slots where they are arranged,
the body of said oblong attachment screws passing through the oblongs and passing beyond the thickness of the output flange in order to couple to the input flange.

7. The system of claim 1, wherein the articulated pins are available around the inner circumference of the input flange and are coupled to fitting structures coincidentally available along the circumference of the output flange in order to promote coupling between the input and output flanges, with the contribution of the input flange attachment screws and the output flange attachment screws.
